(19) United States
(12) Patent Application Publication
(10) Pub. No.: US 2025/0341850 A1
(43) Pub. Date: Nov. 6, 2025

(54) INTEGRATED CIRCUIT FOR POWER SUPPLY GLITCH IMMUNE INTERMEDIATE VOLTAGE SUPPLY AND A METHOD THEREOF

(71) Applicant: SAMSUNG ELECTRONICS CO., LTD., Suwon-si (KR)

(72) Inventors: Parthavy Rayabarapu, Bengaluru (IN); Aswani Aditya Kumar Tadinada, Bengaluru (IN); Subba Reddy Siddamurthy, Bengaluru (IN); Venkatasuryam Setty Issa, Bengaluru (IN)

(21) Appl. No.: 18/758,728

(22) Filed: Jun. 28, 2024

(30) Foreign Application Priority Data
May 3, 2024 (IN) 202441035341

(51) Int. Cl. G05F 3/24; G05F 1/46; G05F 1/565

(52) U.S. Cl. CPC G05F 3/247; G05F 1/468; G05F 1/565

(57) ABSTRACT

The present disclosure relates to an integrated circuit for generating an intermediate supply voltage which is immune to glitches on power supply voltage. An example integrated circuit comprises a Band Gap Reference (BGR) circuit configured to generate a reference voltage immune to glitches on a power supply. The integrated circuit also comprises a Low Dropout (LDO) circuit which gets the reference voltage from the BGR circuit. The LDO circuit is configured to generate a glitch immune intermediate supply voltage based on the reference voltage and the power supply which is prone to glitch.

### BACKGROUND

In power integrated circuits, there can be unexpected supply glitches, which are sudden and can be either positive or negative. To address this, glitch detectors employed in the power-integrated circuits play a crucial role. The glitch detectors are responsible for identifying abrupt changes in the supply and raising a flag as a signal. However, it is important that the operation of the glitch detectors should not be affected due to such supply glitch conditions.

Generally, such power integrated circuits include a Band Gap Reference (BGR) circuit that ensures reliable output and a Low Dropout (LDO) circuit that supplies a clean supply to such glitch detectors even when there is a glitch in the actual power supply.

Further, the BGR circuit includes a low pass filter for mismatch averaging during chopping. However, a conventional BGR circuit includes a switch cap based notch filter for average chopping voltage that suffers from supply glitch and impacts the final output voltage of the BGR and LDO. Also, during supply glitch condition, when an input power supply is less than an output voltage of the LDO, a reverse current path is formed from an input to an output of the LDO, which needs a huge capacitor at the output of the LDO to maintain its value.

FIGS. 1A-1B illustrate a problem associated with a conventional filtering circuit used in a BGR circuit 100, according to state of the art. During a negative supply glitch condition, the switch 101 control voltage clock/clock B (CLK/CLKB) in OFF state reduces, which turns ON both the switches 101, 102. Due to this undershoot, a notch filter PMOS is turned on by the CLK/CLKB, thereby passing the glitch on an unfiltered BGR voltage (BGR_UNFILT) to the output of the BGR circuit 100, i.e., filtered BGR voltage (BGR_FILT). Further, said glitch on the BGR_FILT takes filter settling time of around 5 time constants to settle to an intended voltage resulting in performance degradation of the glitch detectors.

FIGS. 2A-2B illustrate a problem associated with a conventional LDO circuit 200, according to the state of the art. The conventional LDO circuit 200 includes a high load capacitor (C_{Load}). During the supply glitch condition, the high load capacitor (C_{Load}) subsidizes the variation in the output voltage (VOUT). However, such high load capacitor (C_{Load}) when implemented externally needs an additional pin and pad, and when implemented on-chip, impacts other performance metrics of the LDO circuit 200. Further, as shown in FIG. 2B, when the input power supply voltage (AVDD) is less than an output voltage (VOUT) of the LDO circuit 200, a reverse current path is formed from an input to an output of the LDO circuit 200, which also highly impacts the operation of the LDO and needs an even bigger capacitor on the output to stabilize the conventional LDOs.

Thus, it is desired to address the above-mentioned disadvantages or other shortcomings of the BGR and the LDO circuits in the presence of high supply glitches.

### SUMMARY

This summary is provided to introduce a selection of concepts, in a simplified format, that are further described in the detailed description of the present disclosure. This summary is neither intended to identify essential concepts of the present disclosure nor is it intended for determining the scope of the present disclosure.

In general, according to some aspects, an integrated circuit for generating an intermediate supply voltage that is immune to glitches on power supply voltage is disclosed. The integrated circuit includes a Band Gap Reference (BGR) circuit configured to generate a reference voltage immune to glitches on the power supply. The integrated circuit also includes a Low Dropout (LDO) circuit which gets the reference voltage from the BGR circuit. The LDO circuit is configured to generate glitch-immune intermediate supply voltage based on the reference voltage and the power supply which is prone to glitches.

In general, according to some aspects, a method for generating a power supply glitch immune, intermediate supply voltage is disclosed. In an integrated circuit that comprises a Band Gap Reference (BGR) circuit and a Low Dropout (LDO) circuit, the method includes receiving, by the BGR circuit, an input power supply, the method also includes generating, by the BGR circuit, a reference voltage immune to glitch on the input power supply. The method further includes generating, by the LDO circuit, an intermediate voltage, by taking the reference voltage from BGR and the input power supply.

To further clarify the advantages and features of the present disclosure, description of the present disclosure will be rendered by reference to implementations thereof, which are illustrated in the appended drawings. It is appreciated that these drawings depict only typical implementations of the present disclosure and are therefore not to be considered limiting of its scope. The present disclosure will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIGS. 1A-1B illustrate a problem associated with a conventional filtering circuit used in a Band Gap Reference (BGR) circuit, according to state of the art.

FIGS. 2A-2B illustrate a problem associated with a conventional Low Dropout (LDO) circuit, according to state of the art.

FIG. 3 illustrates a block diagram of an example of a supply glitch detector system.

FIG. 4 illustrates a circuit diagram of an example of a filtering circuit used in the BGR circuit.

FIG. 5 illustrates a circuit diagram of an example of a LDO circuit.

FIG. 6 illustrates an example of a proportional path circuit.

FIG. 7 illustrates an example of a differential path circuit.

FIG. 8 illustrates an example of a circuit diagram of a LDO circuit.

FIG. 9 illustrates various example waveforms corresponding to glitch on the power supply voltage in the LDO circuit.

FIG. 10 is a flow chart of an example of a method for generating an intermediate supply voltage that is immune to glitch on power supply.

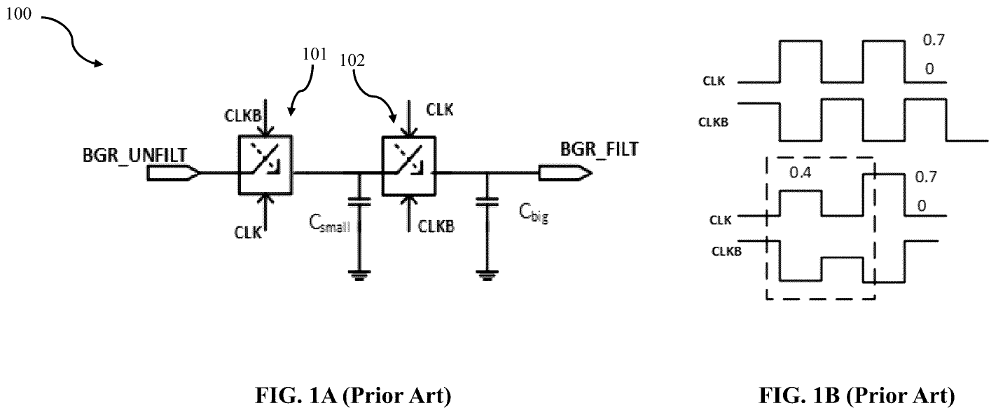

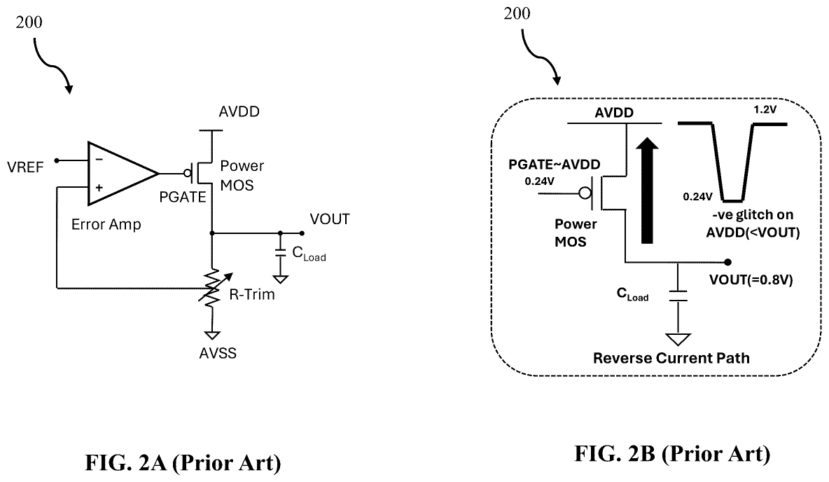

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the implementations of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the implementation illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the implementation is included in at least one implementation of the present disclosure. Thus, appearances of the phrase “in an implementation”, “in one implementation”, “in another implementation”, and similar language throughout this specification may, but do not necessarily, all refer to the same implementation.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The implementations herein and the various features and advantageous details thereof are explained more fully with reference to the non-limiting implementations that are illustrated in the accompanying drawings and detailed in the following description. Descriptions of well-known components and processing techniques are omitted so as to not unnecessarily obscure the implementations herein. Also, the various implementations described herein are not necessarily mutually exclusive, as some implementations can be combined with one or more other implementations to form new implementation. The term “or” as used herein, refers to a non-exclusive or unless otherwise indicated. The examples used herein are intended merely to facilitate an understanding of ways in which the implementation herein can be practiced and to further enable those skilled in the art to practice the implementation herein. Accordingly, the examples should not be construed as limiting the scope of the implementation herein.

As is traditional in the field, implementation may be described and illustrated in terms of blocks that carry out a described function or functions. These blocks, which may be referred to herein as units or modules or the like, are physically implemented by analog or digital circuits such as logic gates, integrated circuits, microprocessors, micro-controllers, memory circuits, passive electronic components, active electronic components, optical components, hardwired circuits, or the like, and may optionally be driven by firmware and software. The circuits may, for example, be implemented in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the implementation may be physically separated into two or more interacting and discrete blocks without departing from the scope of the present disclosure. Likewise, the blocks of the implementation may be physically combined into more complex blocks without departing from the scope of the present disclosure.

The accompanying drawings are used to help easily understand various technical features and it should be understood that the implementation presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The present disclosure provides an on-chip Low Dropout (LDO) that is immune to power supply glitch. The present disclosure also discloses a Band Gap Reference (BGR) circuit with a cascade Resistor-Capacitor (RC) filter and a switch cap based notch filter and reduces ripple on the output of the BGR circuit during power supply glitch.

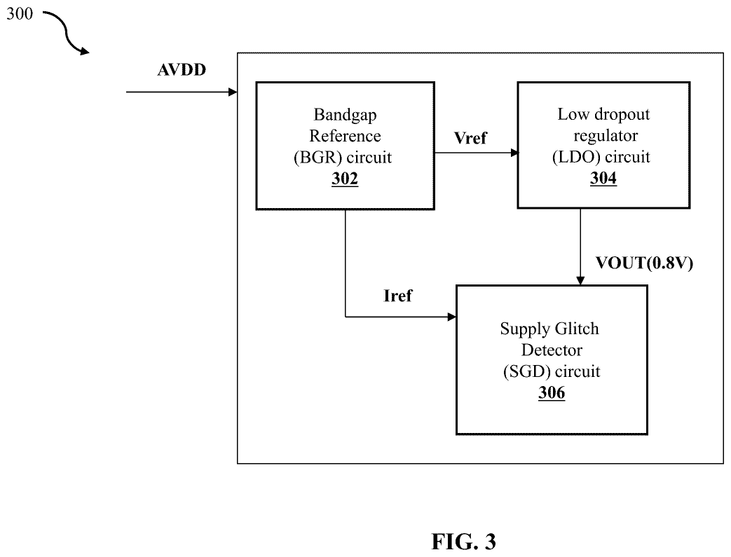

FIG. 3 illustrates a block diagram of an example of a supply glitch detector system 300 (also referred to as “the system 300”). The system 300 may also be referred to as an integrated circuit 300 for generating an intermediate supply voltage which is immune to glitches on power supply voltage. Further, the system 300 includes a BGR circuit 302, an LDO regulator circuit 304 (also referred to as “the LDO circuit 304”), and a Supply Glitch Detector (SGD) circuit 306. The system 300 may be implemented at an electronic device such as, but not limited to, mobile phones, personal computing devices, laptops, tablets, and so forth. The system 300 may be configured to monitor the power supply in the electronic device. The system 300 may be configured to detect sudden changes or glitches in the supply voltage, which may be caused by factors such as, but not limited to, power supply noise, voltage spikes, or disturbances. In some implementation, the power supply glitches may be caused by an external attacker to disable the system 300 to gain access to sensitive information being stored and/or communicated by the electronic device.

The BGR circuit 302 may be configured to generate a stable and accurate reference voltage (Vref) based on a received input power supply voltage (AVDD) (interchangeably referred to as “power supply (AVDD)”, or “supply voltage (AVDD), or “input voltage (AVDD)). The BGR circuit 302 may be designed to be relatively insensitive to temperature and process variations and may be used to generate a stable voltage reference for other components in the electronic device and/or the system 300.

The LDO circuit 304 may be configured to provide a stable and regulated output voltage (VOUT). In some implementations, the LDO circuit 304 may be configured to maintain the constant output voltage (VOUT) when the input power supply voltage (AVDD) experiences fluctuations or glitches.

The SGD circuit 306 may be configured to monitor the power supply voltage of the electronic device. The SGD circuit 306 may be configured to compare the reference voltage (Vref) received from the BGR circuit 302 with the input voltage (AVDD) and/or the output voltage (VOUT) generated by the LDO circuit 304, to detect if there is any deviation or glitch in the power supply voltage/input voltage (AVDD) that is beyond a certain threshold.

In some implementations, the output voltage (VOUT) from the LDO circuit 304 is required to ensure proper functioning of the SGD circuit 306 and/or other components of the electronic device. In particular, the SGD circuit 306 is configured to detect a glitch in the supply voltage (AVDD) and for the proper functioning of the SGD circuit 306 during the power supply glitch conditions, the BGR circuit 302 and the LDO circuit 304 provide a cleaner reference voltage and clean voltage supply, respectively. Further, each of the BGR circuit 302, the LDO circuit 304, and the SGD circuit 306 is supplied with a common input power supply (AVDD) which experiences glitches that need to be detected by the system 300.

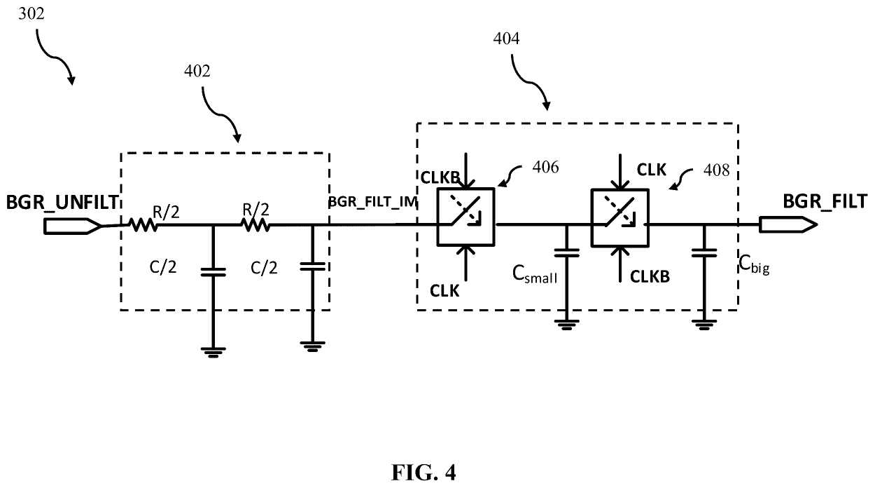

FIG. 4 illustrates a circuit diagram of an example of the filtering circuit used in the BGR circuit 302. The BGR circuit 302 is configured to generate the reference voltage (Vref) that is immune to glitches on the input power supply. The BGR circuit 302 may include a cascaded Resistor-Capacitor (RC) filter 402 and one or more switched-capacitor (SC) based notch filter circuit 404. The cascaded RC filter 402 includes a pair of RC circuits where each resistor is referred to as “R/2” and each capacitor is referred to as “C/2”. The cascaded RC filter 402 may be configured to reduce the ripple on the output voltage (BGR_FILT) of the BGR circuit 302. In particular, the cascaded RC filter 402 may be configured to filter out large ripples on input voltage (BGR_UNFILT) and thereby reduce ripple at an input voltage (BGR_FILT_IM) of the one or more SC-based notch filter circuit 404. The SC-based notch filter circuit 404 includes a pair of switches controlled by a pair of clock signals (CLK/CLKB) such that at any time only one switch is ON. Specifically, the SC-based notch filter circuit 404 includes a first switch 406 coupled with a first capacitor (Cₛₘₐₗₗ), and a second switch 408 coupled with a second capacitor (C_{big}). In some implementations, each of the first switch 406 and the second switch 408 may be a P-channel Metal-Oxide-Semiconductor Field-Effect Transistor (PMOS) switch. Further, the first capacitor (Cₛₘₐₗₗ) may have a small capacitance value and the second capacitor (C_{big}) may have a high capacitance value. Moreover, each of the first switch 406 and the second switch 408 may be driven using a pair of clock signals (CLK/CLKB). In some implementations, the pair of clock signals (CLK/CLKB) may be inversely applied on the first switch 406 and the second switch 408.

In some implementations, the cascaded RC filter 402 may act as a filter to average BGR voltage in different chopping phases to enable the chopping operation of the BGR circuit 302. The SC-based notch filter circuit 404 may be employed to further average the BGR_FILT_IM voltage. It also helps to filter out unwanted noises or glitches on the supply voltage, transient ripples on BGR voltage when switching from one chopping phase to another chopping phase. In particular, the SC-based notch filter circuit 404 uses periodic charging/discharging of the capacitors (Cₛₘₐₗₗ, C_{big}) to achieve filter operation. The SC-based notch filter circuit 404 may be configured to enable the BGR circuit 302 to generate the stable reference voltage (Vref). In some implementations, the cascaded RC filter 402 and the SC-based notch filter circuit 404 may be configured to average the unfiltered output of the BGR circuit 302 to reduce the transient ripples on the BGR output during the power supply glitch and chopping operation.

In some implementations, the BGR circuit 302 may generate temperature stabilized reference voltage by combining two voltages/currents having opposite polarity temperature coefficients by using operational amplifier, a Complimentary to Absolute Temperature (CTAT) voltage source, a Proportional to Absolute Temperature (PTAT) voltage source, and current mirrors. In some implementation, the BGR circuit 302 for sub-1V applications uses voltage/current choppers, to achieve reliable reference voltage, for reducing random offset in an Operational Trans-conductance Amplifier (OTA) and reducing current mismatches in mirrors circuit. Further, the BGR circuit 302 uses a low pass filter for averaging out mismatches during voltage/current chopping operation.

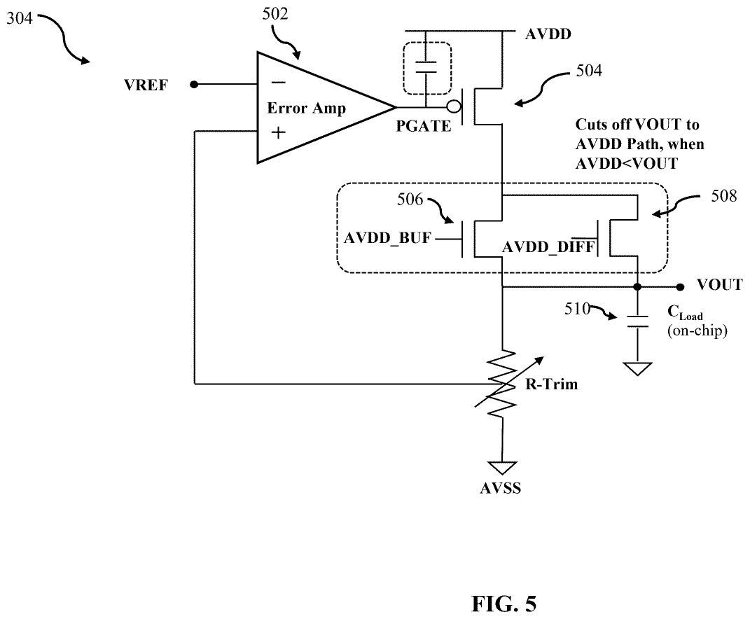

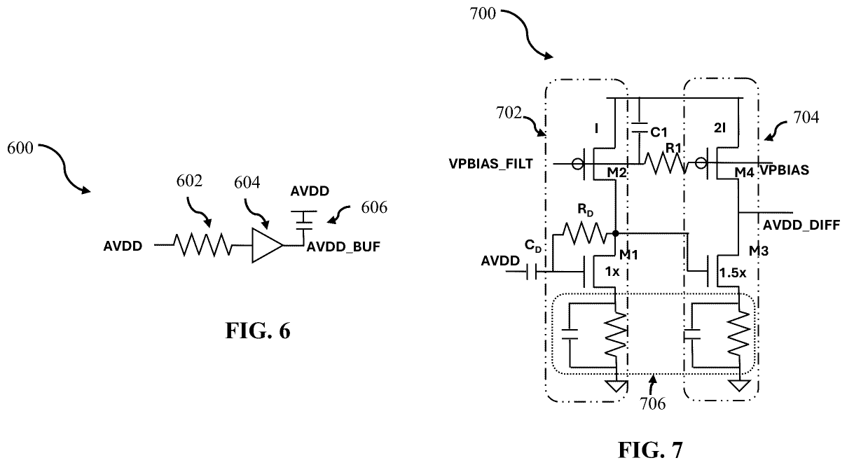

FIG. 5 illustrates a circuit diagram of an example of the LDO circuit 304. As an initial point, the LDO circuit 304 includes an error amplifier 502 configured to receive a reference voltage (V_{ref}) as input. In some implementations, the error amplifier 502 corresponds to an operational amplifier (Op-Amp) having an inverting terminal and a non-inverting terminal. The error amplifier 502 is configured to receive the reference voltage (V_{ref}) on the inverting terminal as one input. In some implementations, the reference voltage (V_{ref}) is supplied by the BGR circuit 302. Further, the error amplifier 502 is configured to receive fraction of the LDO output voltage as feedback voltage on the non-inverting terminal as another input. Further, an output of the error amplifier 502 is fed to a pass element 504 that corresponds to any suitable type of MOSFET including a PMOS and a N-channel MOSFET (NMOS). In some implementations, the pass clement 504 may be a PMOS configured to receive input power supply (AVDD) as input and operate based on the output of the error amplifier 502. In some implementations, the pass element 504 is configured to transfer a current from the input power supply (AVDD) to a load. The LDO circuit 304 also includes a load capacitor 510, which ensures that the current is delivered immediately to the load during load transients until the error amplifier updates the control voltage of the pass element 504.

In some implementations, to prevent reverse current path in the negative power supply glitch condition, the LDO circuit 304 includes a pair of NMOS switches 506 and 508 which are controlled by a proportional path signal (AVDD_BUFF) and a differential path signal (AVDD_DIFF), respectively. The pair of NMOS switches 506 and 508 is configured to cut off the reverse current path when the input power supply voltage is less than the LDO output voltage, i.e., AVDD<VOUT.

The proportional path signal (AVDD_BUFF) may be generated without any delay, i.e., the proportional path signal (AVDD_BUFF) may be generated instantaneously during the supply glitch condition. The differential path signal (AVDD_DIFF) may be generated with a little lag at the start of the supply glitch condition, however, the differential path signal (AVDD_DIFF) may have a higher slew and amplified response after initial lag.

The proportional path signal (AVDD_BUFF) and the differential path signal (AVDD_DIFF) may assist the LDO circuit 304 to limit an impact of the negative supply glitch condition, i.e., when AVDD<VOUT.

The LDO circuit 304 may implement a dominant pole compensation technique to meet stability and transient performance. Specifically, the LDO circuit 304 may add a conventional differentiator on the output voltage (VOUT) that reduces the drive of the PMOS 504 during the positive power supply glitch condition. Additionally, this improves stability and transient performance.

In one non-limiting example, the LDO circuit 304 may be configured to provide a clean output of 0.8V, when there is a supply glitch, which makes power supply as low as 0.2V or as high as 2.48V. Therefore, the LDO circuit 304 may enable the SGD circuit 306 to operate even during the negative supply glitch i.e., power supply as low as 0.2V. Also, the LDO circuit 304 prevents the need of a high value capacitor at the load.

FIG. 6 illustrates an example of a proportional path circuit 600. The proportional path circuit 600 includes a resistor 602, a buffer 604, and a capacitor 606. The proportional path circuit 600 is configured to provide the proportional path signal (AVDD_BUFF) to the NMOS switch 506 of the LDO circuit 304. The capacitor 606 in the proportional path circuit 600, passes the power supply (AVDD) glitch on to AVDD_BUFF in proportion. The resistor 602 and the buffer 604 in the proportional path circuit 600 provide the static voltage of AVDD_BUFF. The resistor 602 may support an Electronic Discharge (ESD) requirement of the buffer 604 in the proportional path circuit 600. The buffer 604 may be configured to pull the proportional path signal (AVDD_BUFF) to “0” in power down condition.

FIG. 7 illustrates an example of a differential path circuit 700. The differential path circuit 700 may be configured to provide differential path control signal (AVDD_DIFF) to the NMOS switch 508 of the LDO circuit 304. The differential path circuit 700 may include a first stage 702 and a second stage 704. The first stage 702 may include a capacitor C_{D}, a resistor R_{D}, and a diode-connected MOS M1. The first stage 702 may be configured to detect glitches in the power supply voltage (AVDD) using the capacitor C_{D}. Further, the resistor R_{D} may be placed between a gate terminal and a drain terminal of the diode-connected MOS M1 to amplify the sensed glitch on AVDD.

The second stage 704 of the differential path circuit 700 is configured to amplify the signal near to rail-to-rail and in-phase with the power supply voltage (AVDD). During the start-up phase, the first stage 702 load bias M2's gate is delayed with respect to second stage 704 load bias M4's gate using a filter to avoid rail-to-rail oscillations on the differential path signal (AVDD_DIFF) which causes stress on the system 300. The differential path circuit 700 may include an RC degeneration circuit 706 on input transistors on both stages to make the LDO circuit 304 immune to small ripples on power supply at 1 MHz-1 GHz.

In one non-limiting example, the LDO circuit 304 may include the proportional path circuit 600 and the differential path circuit 700.

In some implementations, the proportional path signal (AVDD_BUFF) and the differential path signal (AVDD_DIFF) are full-swing (0-AVDD) signals which are generated using rail-to-rail inverters, using low-voltage devices.

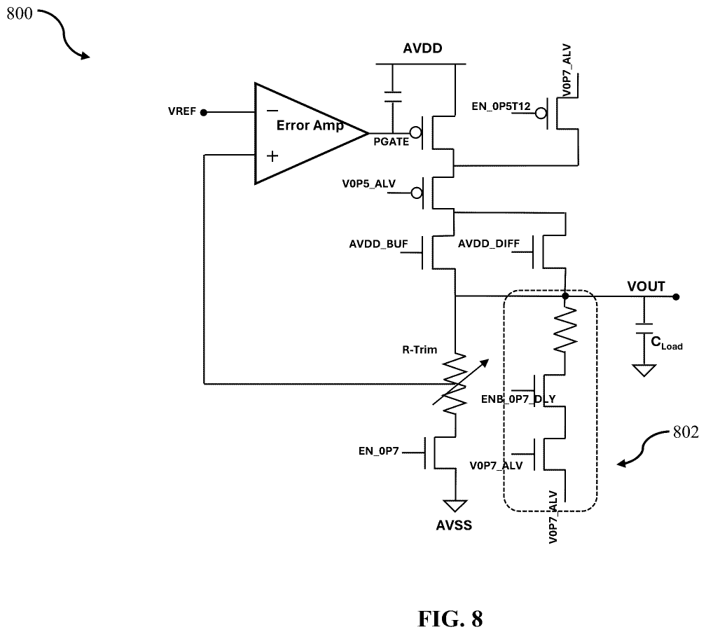

FIG. 8 illustrates an example of a circuit diagram of a LDO circuit 800. The LDO circuit 800 may have similar components as discussed in reference to the LDO circuit 304 in FIG. 5. The LDO circuit 800 includes a delayed enabling path 802 that is added in parallel to trim resister (R-Trim) of the LDO circuit 800. The delayed enabling path 802 reduces stress on the other components of the LDO circuit 800 during a start-up phase by ensuring none of the transistor junctions of the LDO circuit 800 experiences voltage greater than 0.95V across them. The delayed enabling path 802 includes a resister and one or more MOS devices.

In some implementations, during an OFF state, the output voltage (VOUT) is maintained at a voltage slightly less than 0.7V by the delayed enabling path 802. Further, during the OFF state, both the proportional path signal (AVDD_BUFF) and the differential path signal (AVDD_DIFF) may be at 0. Further, a drain terminal of the pass element (i.e., PMOS switch) is pulled to 0.7V and a gate terminal of the pass element is to 1.2V to avoid stress of the devices.

Further, during an OFF to ON state transition, the LDO circuit 800 is enabled, i.e., the trim resistor (R-Trim) path is turned ON and the delayed enabling path 802 is turned OFF with some delay to avoid Electrical over Stress (EOS) of the devices/components in the LDO circuit 800. In some implementations, a positive supply glitch condition on the input power supply (AVDD) is limited by dominant pole compensation and by adding a differentiator on VOUT, which reduces over drive of the P-MOS switch of the LDO circuit 800 during positive power supply glitch.

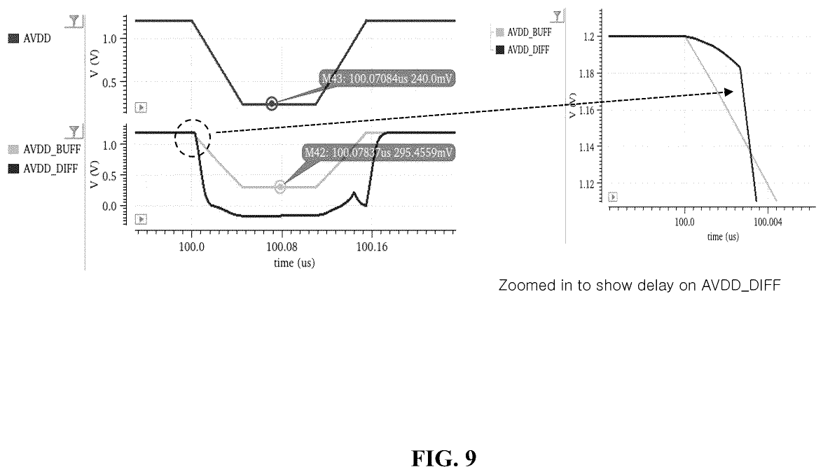

FIG. 9 illustrates various example waveforms corresponding to different voltage supplies in the LDO circuit 800. Specifically, FIG. 9 illustrates waveforms corresponding to the input power supply (AVDD), the proportional path signal (AVDD_BUFF) and the differential path signal (AVDD_DIFF), as discussed in reference to FIG. 8. FIG. 9 illustrates that during glitch on the input power supply (AVDD), the proportional path signal (AVDD_BUFF) responds without any delay and the differential path signal (AVDD_DIFF) will experience a little lag during initial phase of the glitch. However, the differential path signal (AVDD_DIFF) response will be more amplified and quicker than the actual glitch. These characteristics of the proportional path signal (AVDD_BUFF) and the differential path signal (AVDD_DIFF) limit the impact of negative supply glitch on output voltage (VOUT) (˜dVout=I_{load}*T_{glitch}/C_{load}).

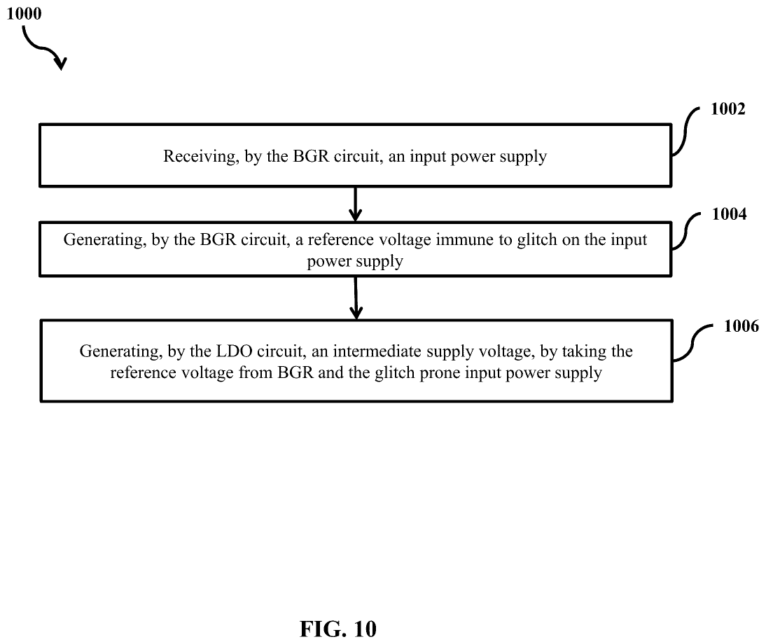

FIG. 10 is a flow chart of an example of a method 1000 for generating an intermediate voltage that is immune to glitch on power supply voltage. In an integrated circuit 300 that comprises the BGR circuit 302 and the LDO circuit 304, at step 1002, the method 1000 includes receiving, by the BGR circuit 302, an input power supply.

At step 1004, the method 1000 includes generating, by the BGR circuit 302, the reference voltage (V_{ref}) immune to glitch on the input power supply (AVDD).

At step 1006, the method 1000 includes generating, by the LDO circuit 304, an intermediate voltage, by taking the reference voltage (V_{ref}) from the BGR circuit and the glitch prone input power supply (AVDD).

The present disclosure discloses the use of a cascaded RC filter with a notch filter in a BGR circuit for averaging filter results reduced ripple on an output of the BGR circuit during power supply glitch condition. Further, the present disclosure discloses an LDO circuit configured to generate clean output of 0.8V, even when there is a power supply glitch which makes supply as low as 0.2V and as high as 2.48V without use of any huge capacitor.

The various actions, acts, blocks, steps, or the like in the flow diagrams may be performed in the order presented, in a different order, or simultaneously. Further, in some implementation, some of the actions, acts, blocks, steps, or the like may be omitted, added, modified, skipped, or the like without departing from the scope of the present disclosure.

Unless otherwise defined, all technical and scientific terms used herein have the same meaning as commonly understood by one ordinary skilled in the art to which this present disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the concept as taught herein. The drawings and the forgoing description give examples of implementation. Those skilled in the art will appreciate that one or more of the described elements may well be combined into a single functional element. Alternatively, certain elements may be split into multiple functional elements. Elements from one implementation may be added to another implementation.

The implementation disclosed herein can be implemented using at least one hardware device and performing network management functions to control the elements.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The foregoing description of the specific implementation will so fully reveal the general nature of the implementation herein that others can, by applying current knowledge, readily modify and/or adapt for various applications such specific implementation without departing from the generic concept, and, therefore, such adaptations and modifications should and are intended to be comprehended within the meaning and range of equivalents of the disclosed implementation. It is to be understood that the phraseology or terminology employed herein is for the purpose of description and not of limitation. Therefore, while the implementation herein have been described in terms of preferred implementation, those skilled in the art will recognize that the implementation herein can be practiced with modification within the scope of the implementation as described herein.

What is claimed is:

1. An integrated circuit for generating an intermediate supply voltage which is immune to glitch on power supply voltage, the integrated circuit comprising:
a Band Gap Reference (BGR) circuit configured to generate a reference voltage immune to glitch of a power supply; and
a Low Dropout (LDO) circuit configured to receive the reference voltage from the BGR circuit, wherein the LDO circuit is configured to generate a glitch-immune intermediate supply voltage based on the reference voltage and the power supply.

2. The integrated circuit as claimed in claim 1, wherein
the BGR circuit comprises a cascaded Resistor-Capacitor (RC) filter and at least one switched-capacitor based notch circuit, and
the cascaded RC filter is configured to filter one of an overshoot or an undershoot in the reference voltage.

3. The integrated circuit as claimed in claim 1, wherein the LDO circuit comprises:
a first circuitry forming a proportional path, wherein the first circuitry includes a set of one or more resistors, one or more buffers, and one or more first capacitors;
a second circuitry forming a differential path, wherein the second circuitry includes a plurality of second capacitors;
a plurality of MOS transistors; and
a filter.

4. The integrated circuit as claimed in claim 3, wherein the first circuitry is configured to sense a glitch in a main power supply, and to generate a first control signal; and
wherein the second circuitry is configured to amplify transition on the main power supply, and to generate a second control signal with lag to the first control signal, the second control signal controlling the plurality of MOS transistors to generate the intermediate supply voltage.

5. The integrated circuit as claimed in claim 1, wherein the LDO circuit comprises
a third circuitry forming a delayed enabling path, wherein the third circuitry includes a plurality of resistors and a plurality of MOS transistors, and the third circuitry is connected in parallel to a trim resistor connected to an output terminal of the LDO circuit.

6. A method for generating a power supply glitch immune intermediate supply voltage, the method comprising,
in an integrated circuit that comprises a Band Gap Reference (BGR) circuit and a Low Dropout (LDO) circuit:
receiving, by the BGR circuit, an input power supply;
generating, by the BGR circuit, a reference voltage immune to glitch of the input power supply; and
generating, by the LDO circuit, an intermediate voltage based on the reference voltage from BGR and the input power supply.

7. The method as claimed in claim 6, wherein the BGR circuit comprises a cascaded Resistor-Capacitor (RC) filter and at least one switched-capacitor based notch circuit, and the method comprises
filtering, by the cascaded RC filter, one of an overshoot or an undershoot in the reference voltage.

8. The method as claimed in claim 6, wherein the LDO circuit comprises:
a first circuitry forming a proportional path, wherein the first circuitry includes a set of one or more resistors, one or more buffers, and one or more first capacitors;
a second circuitry forming a differential path, wherein the second circuitry includes a plurality of second capacitors;
a plurality of MOS transistors; and
a filter.

9. The method as claimed in claim 8, wherein the method comprises:
sensing, by the first circuitry, a glitch in a main power supply;
generating, by the first circuitry, a first control signal based on the main power supply;
amplifying, by the second circuitry, transition on the main power supply; and
generate a second control signal with lag to the first control signal, the second control signal controlling the plurality of MOS transistors to generate an intermediate supply voltage.

10. The method as claimed in claim 6, wherein the LDO circuit comprises:
a third circuitry forming a delayed enabling path, wherein the third circuitry includes a plurality of resistors and a plurality of MOS transistors, and the third circuitry is connected in parallel to a trim resistor connected to an output terminal of the LDO circuit.
